(19) United States
(12) Patent Application Publication
(10) Pub. No.: US 2007/0118488 A1
(43) Pub. Date: May 24, 2007

(54) Mail Delivery Notification Process

(76) Inventors: Robert E. Bozzomo, Berkeley Heights, NJ (US); Khaled Nassoura, Warren, NJ (US); Robert Bozzomo, Berkeley Heights, NJ (US)

Correspondence Address: Mr.Robert E. Bozzomo, 65 Old Cannon Road, Berkeley Heights, NJ, 07922, US

(21) Appl. No.: 11/164,016

(22) Filed: Nov. 7, 2005

(51) Int. Cl. B65B 35/00; G06F 17/00; G07B 17/02

(52) U.S. Cl. 705/406

(57) ABSTRACT

A mail delivery notification arrangement for maximizing the efficiency of notification and mail pick up on a regular basis. In this embodiment, the mail drop off location utilizes a bar code, RFID or other identifying and notification methods as input to the process. When a letter or package is received or placed at a mail drop off location, the unique identifier is read and recognized by the delivery process agent. The delivery process agent will log the date and time of delivery, quantity of items delivered, and types of items delivered (e.g. certified mail, registered mail, regular mail, overnight package). The data is then transferred by the delivery process to the system's database server(s) which notify the corresponding user of the mail or package drop off. The notification to the user can contain one or more of the following relevant attributes: date and time of receipt at the drop off location, types and number of items received, and sender's name and address. The process embodied in this invention will have a significant impact on productivity. People will no longer have to go to their mail location to check for mail. The notification system process will enable people to make the determination if and when to visit their mail drop off locations to retrieve incoming deliveries. Time and money will be saved. Fuel will be saved as a result of eliminating non-essential or unproductive trips to the mail drop off location as well as the ability to notify others to pick up delivery.

### BACKGROUND OF THE INVENTION

Mail delivery systems have been in existence for centuries. However, such systems have always lacked a notification process by which the recipient is informed in real-time of the mail delivery time and other relevant delivery information.

Today, mail box subscribers or owners, whether they are part of a national postal system, a private postal system, or private mail delivery systems in business and organizations, lack the useful and timely information of knowing when and what type of mail has been deposited into their mailboxes or other drop locations. Such a notification process will improve productivity by reducing wasteful visits or trips to the mail drop off locations. Moreover, such a notification process will contribute to timely communications by enabling the mailbox subscriber or owner to pick up his or her mail deliveries as soon as they have been deposited.

Current approaches to this problem are based on mechanical or electro-mechanical devices that sense or detect the occupancy state of a mailbox. Moreover, such approaches require the installation of a complex system of devices, wiring, controllers, and processors and subsequent on-going maintenance.

This invention is far superior to any existing solutions because it employs a fully automated process that overlays existing systems and does not utilize any of the above mentioned detection techniques. The present invention embodies a new automated process by which the mail system provider, whether public or private, can notify the mail system subscribers of the date, time, quantity, and type of mail that have been delivered to the subscribers mail drop off location as well as the name and address of the sender if available. This invention does not require devices of any type to be installed at or near the mailbox or shipment drop off location. Instead, a label that contains a unique identifier, which can be machine or human readable, is affixed to the drop off location. The mail system provider can now log the user's unique ID at time of delivery by using existing technologies such as barcode, RFID, and the like. This information can then be uploaded to the mail system provider network of computer databases and servers. Furthermore, the mail system provider can then notify the user of the delivery date and time and type of delivery through the use of a variety of existing communication technologies such as the internet, email, instant messaging, telephone, pager, and the like.

### BRIEF DESCRIPTION OF THE DRAWINGS

FIG. 1 is a flowchart diagram of the mail delivery notification process.

FIG. 2 is system diagram of the mail delivery notification system.

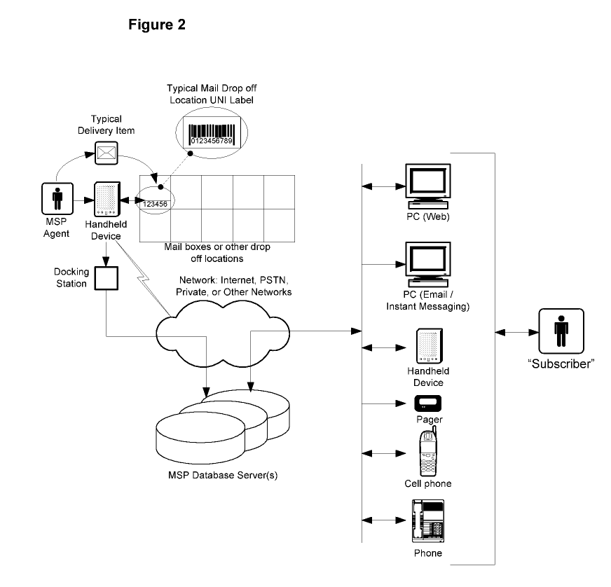

Definition List 1

| Term | Definition |
|---|---|
| Mail drop off location | Any location, including but not limited |
| | to, mail boxes, mail slots, designated |
| | shipment areas, or any other area that is |
| | used for receiving mail and other |
| | delivery items. |
| Delivery process agent | It is an individual, or a device or a |
| | combination of the two, which scans the |
| | unique notification identifier (UNI) upon |
| | delivery of mail and logs any additional |
| | relevant information. |
| Mailbox subscriber | The individual who sends and receives |
| | mail or deliveries under the domain of |
| | the mail system provider (MSP). |
| Universal Notification | A unique identifier that is issued by the |
| Identifier (UNI) | mail system provider (MSP) to the |
| | mailbox subscriber. This identifier is |
| | affixed to the mail drop off location. |
| | This identifier is assigned to the |
| | subscriber and is portable to the |
| | subscriber's future drop off location |
| | within the mail system provider's |
| | domain. |
| Mail System Provider | A national postal system, a private postal |
| (MSP) | system, or private mail delivery systems |
| | in business and organizations which |
| | send, sort, and deliver mail. |

### DETAILED DESCRIPTION OF PREFERRED EMBODIMENTS

The present invention is an arrangement of processes for real-time notification of the arrival or deposit of mail and other shipping items at a variety of location types.

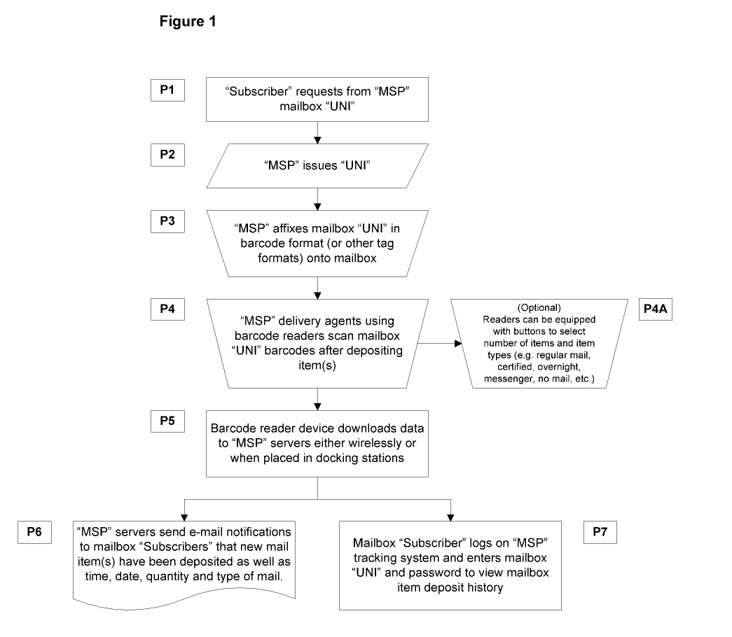

Processes 1 and 2 of FIG. 1 describe the processes for registering and obtaining a unique identifier referred to herein as the Universal Notification Identifier (UNI) for the mail delivery notification system. The mail system provider (MSP) can be one that is operated by a national postal system such as the US Postal Service, a private rental mailbox enterprise such as the UPS Store or corporate or institutional mail system. Furthermore, mail or shipment drop-off locations can be in various forms such as, but not limited to, a cluster of mailboxes such as the ones found at post offices, residential and business complexes, or a business mail center; or individual locations such as small businesses or residential mailboxes or mail slots. A user that belongs to or subscribes to the MSP is assigned upon request a UNI. The MSP affixes the UNI to the Subscriber's mailbox or drop-off location as described in Process 3 of FIG. 1. The UNI can be in a variety of formats including, but not limited to, barcode, tag, RFID, or any other human or machine readable format.

Process 4 of FIG. 1 describes how the MSP personnel deliver mail to the Subscribers' designated mailboxes or other shipment drop-off locations. In the current embodiment upon item delivery, the MSP delivery agent scans the Subscriber's UNI using a handheld device capable of reading and identifying the UNI. As an added service as described in Process 4A of FIG. 1, the MSP delivery person can also log any special delivery type options such as express mail, certified mail, overnight delivery, messenger delivery, no mail, etc. The date and time are logged in by the handheld device automatically at time of scan.

The data stored in the handheld scanner is uploaded to the MSP's database system as described in Process 5 of FIG. 1. The upload process can occur immediately after the scanning of UNI if the scanner is equipped with wireless transmission technology; alternatively, upon the return of the MSP's delivery agent to his base, the handheld scanner can be docked in a hardwired docking station which can transmit the stored data via a local area network, wide area network, or internet to the MSP's database system.

The MSP's database system as described in Process 6 of FIG. 1 is designed to automatically notify the Subcribers upon receipt of the delivery data. The notification process can be affected through the use of one or more of several notification methods pre-determined by the Subscriber. These methods include, but are not limited to, e-mail, Instant Messaging, SMS text messaging, pager, or voicemail.

Alternatively, as described in Process 7 of FIG. 1, the Subscriber can proactively contact the system database to inquire about the notification status as well as retrieve notification and delivery information history through the use of a web interface, a telephone interactive voice response (IVR) system, or other retrieval technologies. The Subscribers can log onto these systems by using their UNI and passwords.

What is claimed is:

1. The process of issuing a UNI to the mail delivery notification process “Subscriber. The UNI is a unique ID that can consist of a combination of number and/or character sequence.

2. The process of storing the Subscriber's UNI in a service database and associating it with a physical mailbox, other physical delivery receptacle, or any other drop off location.

3. The process of affixing the UNI label, barcode, tag, RFID, or any other human or machine readable format to the physical mailbox, other physical delivery receptacle, or any other delivery location.

4. The process of reading the UNI by the mail delivery service at the time of mail delivery to the UNI's associated physical mailbox, other physical delivery receptacle, or any other delivery location.

5. The process of claim 6.4 requires the mail delivery service to use a device that is capable of reading a machine-readable UNI label or alternatively, the delivery agent should be capable of reading a human-readable UNI label.

6. The process of recording the number of mail items and mail types such as regular mail, certified, overnight mail, messenger delivery and other such mail delivery types into the mail delivery reader device.

7. The process by which the mail delivery notification Reader device uploads all stored data to the service database utilizing wired, wireless or any other transmission systems.

8. The process by which the service, upon receipt of the Reader device data, notifies the Subscriber of the mail delivery and the mail delivery type, if applicable.

9. The process of claim 6.8 can be executed via several methods including, but not limited to, e-mail, voicemail, pager, text messaging, instant messaging, and other such communication methods.

10. The process of the Subscriber accessing his/her mail delivery account to gain access to notification and other relevant mail delivery information history.

11. The process of claim 6.10 can be performed via Interactive Voice Response (IVR) systems, PC web access, Internet-enabled devices such as handheld PDAs, cellular telephones and other such devices and systems.
